(19) United States
(12) Patent Application Publication
(10) Pub. No.: US 2015/0108722 A1
(43) Pub. Date: Apr. 23, 2015

(54) Combustion chamber gasket seal for combustion engines of vehicles, preferably of motor vehicles

(71) Applicant: KACO GmbH + Co., KG, Heilbronn (DE)

(72) Inventors: Frank Berg, Bretten (DE); Massimiliano Casini-Cherici, Buchloe (DE); Marcus Teller, Heilbronn (DE)

(21) Appl. No.: 14/516,629

(22) Filed: Oct. 17, 2014

(30) Foreign Application Priority Data
Oct. 17, 2013 (DE) 10 2013 017 499.6

(51) Int. Cl. F02F 11/00

(52) U.S. Cl. CPC F02F 11/002
USPC 277/596

(57) ABSTRACT

A combustion chamber gasket seal for internal combustion engines of vehicles, preferably of motor vehicles, comprising an injector sleeve which projects into a combustion chamber of a cylinder head and carries at least one elastomer sealing ring that seals the combustion chamber relative to the exterior, comprises a sealing ring which is arranged detachably on the injector sleeve and is seated on the injector sleeve with elastic deformation at least with force fit.

### BACKGROUND OF THE INVENTION

The invention concerns a combustion chamber gasket seal for internal combustion engines of vehicles, preferably of motor vehicles, comprising an injector sleeve projecting into a combustion chamber of a cylinder head and carrying at least one elastomer sealing ring that seals the combustion chamber relative to the exterior.

The injector sleeves comprise a sealing ring for sealing the combustion chamber in which they are inserted, the sealing ring vulcanized onto the exterior side of the injector sleeve. The sealing rings are provided on the exterior with sealing ribs which are elastically deformed in the mounted position. In general, after several mounting and demounting events of the injector sleeve, the sealing ring is worn so much that it must be exchanged. However, since it is vulcanized onto the injector sleeve, the injector sleeve must be exchanged also.

Moreover, the manufacture of the injector sleeve with the sealing ring vulcanized onto it is complex and cost-intensive. The vulcanization process requires a pretreatment of the injector sleeve, in particular when the latter, which is often the case, is in the form of a stainless steel tube. When errors occur upon vulcanization of the sealing ring, the entire stainless steel tube constitutes a reject. In practice, the reject rates in manufacturing the injector sleeves are relatively high.

The invention has the object to design the combustion chamber gasket seal of the aforementioned kind in such a way that multiple mounting and demounting events of the injector sleeve are possible without problem and without an expensive and/or complex configuration being required for this purpose.

### SUMMARY OF THE INVENTION

This object is solved for the combustion chamber gasket seal of the aforementioned kind in accordance with the present invention in that the sealing ring is detachably arranged on the injector sleeve and is seated with elastic deformation on the injector sleeve at least with force fit.

In the combustion chamber gasket seal according to the invention, the solid elastomer sealing ring is not vulcanized onto the injector sleeve but is detachably connected to it. The sealing ring is seated with elastic deformation at least by force fit on the injector sleeve. The elastic deformation and thus the force fit are so strong that the sealing ring when mounted does not shift on the injector sleeve so that a reliable sealing action of the combustion chamber is ensured. Should the sealing ring be damaged and/or worn, it can be pulled off the injector sleeve and can be replaced with a new sealing ring. The injector sleeve itself can be reused. Since the sealing ring is detachably seated on the injector sleeve, no cost-intensive and/or complex manufacture is required as is the case in conventional sealing rings that are vulcanized on.

Upon mounting the injector sleeve, it is in general required to push it through a radial seal which is arranged upstream of the combustion chamber. In doing so, the sealing ring contacts the radial seal. By means of the force fit, it is ensured that, despite this contact, the sealing ring will not be displaced upon insertion of the injector sleeve into the combustion chamber.

It is advantageous when the sealing ring is secured on the injector sleeve additionally in axial direction by at least one form fit connection. It can be designed in various ways, for example, by a roughened surface structure or a surface coating of the injector sleeve in the area of the sealing ring and/or by use of an elastomer with high friction coefficient for the sealing ring.

Form fit according to an advantageous embodiment is provided by at least one raised portions on the injector sleeve. Preferably, the raised portion is formed by a welding bead. It can be applied without problem on the injector sleeve. In particular when the exterior side of the injector sleeve is very smooth, for example, in case of a stainless steel tube, by means of the welding bead it is ensured that the sealing ring, despite the smooth exterior side of the injector sleeve, is reliably secured axially against displacement.

The form fit connection, in particular in the form of a raised portion, can be provided about the circumference of the injector sleeve in individual sections that have a spacing relative to each other. However, it is advantageous when the raised portion extends about the circumference of the injector sleeve. In this way, a perfect axial securing action is ensured. Since the sealing ring is comprised of elastomer material, the raised portion pushes into the inner side of the sealing ring which is appropriately elastically deformed thereby in the area of the raised portion.

The form fit connection extends advantageously in a radial plane of the injector sleeve. There is also the possibility that the form fit connection is arranged within a plane that is angularly positioned relative to the radial plane of the injector sleeve. For such a slantedly positioned form fit connection, pushing on the sealing ring is facilitated also.

In another embodiment, the form fit connection extends advantageously in a coil shape about at least one turn. It is advantageous in this context when the form fit connection, advantageously in the form of a raised portion, is of such a coil shape that two or three turns result which advantageously have a spacing relative to each other. The number of turns depends on the width of the sealing ring and/or the diameter of the injector sleeve. In case of a coil-shaped form fit connection, an optimal axial securing action results.

The sealing ring has advantageously a center part with which it is seated with elastic deformation in the area of the form fit connection on the injector sleeve. The center part has an overlap with the injector sleeve which causes the center part of the sealing ring, when being pushed onto the injector sleeve, to be elastically widened and seated with corresponding elastic deformation with radial pretension on the form fit connection. This radial pretension by elastic deformation of the center part in combination with the form fit connection ensures that the sealing ring is perfectly secured against displacement on the injector sleeve.

In a preferred embodiment, at least one rim area adjoins the center part and has a spacing from the injector sleeve in the unmounted position. In this way, the sealing ring can be pushed simply onto the injector sleeve because only the center part of the sealing ring contacts the injector sleeve.

The rim area of the sealing ring has advantageously, beginning at the center part, a decreasing wall thickness. The rim area of the sealing ring has therefore an elastic bendability by means of which the sealing action of the combustion chamber with mounted injector sleeve is facilitated.

The exterior side of the rim area, viewed in axial section through the sealing ring, is advantageously positioned at a slant relative to the axis of the sealing ring at an acute angle. This configuration of the exterior side of the rim area has the advantage that, when pushing the injector sleeve through the radial seal which is arranged upstream of the combustion chamber, the appropriate sealing element or its sealing edge can glide easily across this slantedly positioned exterior side so that neither the sealing edge nor the sealing ring will be damaged.

In order for the sealing ring to reliably reach its sealing position, the insertion area into the combustion chamber is advantageously designed to widen opposite to the insertion direction of the injector sleeve. The cylinder head has thus an insertion bevel with which in particular a tolerance compensation is provided in a simple way. Even greater tolerances can be compensated in this way because the injector sleeve with its sealing ring can be pushed in any case so far into the combustion chamber that the sealing ring seals the combustion chamber properly. The insertion bevel causes the sealing ring to be elastically deformed more and more strongly upon insertion of the injector sleeve.

The sealing ring has advantageously symmetrical cross-section. This has the advantage that, upon pushing the sealing ring onto the injector sleeve, no special position of the sealing ring must be observed. In such a symmetric cross-sectional configuration, the sealing ring has two rim areas that are projecting away from the center part and have a spacing relative to the injector sleeve in the unmounted state.

When the injector sleeve is mounted, the rim area of the sealing ring is elastically deformed such that it is resting with its exterior side and its inner side areally on the wall of the combustion chamber and on the exterior side of the injector sleeve. Since the rim area in unmounted position has a spacing from the exterior wall of the injector sleeve, the rim area upon impinging on the insertion bevel is first elastically bent radially inwardly and then, upon further insertion of the injector sleeve, is elastically compressed so strongly that the areal contact of the rim part on the wall of the combustion chamber and on the exterior side of the injector sleeve is achieved. The combustion chamber is then properly sealed relative to the exterior.

The invention results not only from the subject matter of the individual claims but also from all information and features disclosed in the drawings and the specification. Even though they may not be subject matter of the claims, they are claimed as important to the invention inasmuch as they are novel relative to the prior art individually or in combination.

Further features of the invention result from the additional claims, the specification, and the drawings.

### BRIEF DESCRIPTION OF THE DRAWINGS

The invention will be explained in more detail with the aid of an embodiment illustrated in the drawing. It is shown in:

FIG. 1 in axial section one half of a combustion chamber gasket seal according to the invention;

FIG. 2 the detail X of FIG. 1 in enlarged illustration;

FIG. 3 an injector sleeve of the combustion chamber gasket seal according to the invention;

FIG. 4 the detail X of FIG. 3 in enlarged illustration.

### DESCRIPTION OF PREFERRED EMBODIMENTS

The combustion chamber gasket seal is used in connection with internal combustion engines of vehicles, in particular of motor vehicles. The combustion chamber gasket seal comprises an injector sleeve 1 which is inserted with one end into a combustion chamber 2 of a cylinder head 3. For sealing the injector sleeve 1 in the combustion chamber 2, a sealing ring 4 is provided which is elastically deformed in mounted position. The injector sleeve 1 is comprised, for example, of high quality steel, preferably stainless steel, but can also be made of other suitable materials such as ceramic materials, other metallic materials, and the like.

The outer diameter of the injector sleeve 1 is slightly smaller than the diameter of the combustion chamber 2. The thus formed narrow annular gap is sealed by the sealing ring 4 which is elastically deformed in the mounted position.

On the end of the injector sleeve 2 which is projecting from the combustion chamber 2, a reinforced ring 7 is provided whose cylindrical inner side 8 forms a continuous extension of the cylindrical inner side 9 of the injector sleeve 1. The ring 7 is surrounded by a radial sealing ring 10 which may be configured in various different embodiments. The radial sealing ring 10 is a cover seal and comprises in the exemplary embodiment a support body 11 which has an L-shape cross-section. The support body 11 is comprised of metallic material or of a hard plastic material and is completely embedded in an elastomer material.

The support body 11 has a cylindrical ring part 12 whose axis coincides with the axis 13 of the injector sleeve 1. The ring part 12 passes at its end which is facing away from the end 5 of the injector sleeve 1 in an arc shape into a radial outwardly oriented annular flange 14. The elastomer part 15 which surrounds the ring part 12 and the annular flange 14 has a transition into a sealing lip 16 which extends at a slant in the direction toward the cylinder head 3 which is contacting seal-tightly the ring 7 by means of an annular sealing edge 17.

The ring part 12 is provided on its exterior side advantageously with a corrugated profile 18 whose corrugation peaks in the mounted position are compressed elastically to such an extent that the exterior side of the ring part 12 forms approximately a cylinder surface. It is positioned seal-tightly on the wall of a through opening 19 of a cylinder head cover 20. The annular flange 14 is resting seal-tightly with intermediate positioning of the elastomer part 15 on the end face 21 of the cylinder head cover 20. Upon mounting of the radial sealing ring, the radial flange 14 forms a stop by means of which a precise mounting position of the radial sealing ring 10 is ensured which is arranged upstream of the sealing ring 4.

The sealing lip 16 can be designed such that it applies a sufficiently great contact pressure of the sealing edge 17 onto the exterior side of the ring. However, it is also possible to provide on the exterior side of the sealing lip 16, at the level of the sealing edge 17, a circumferentially extending recess 22 for receiving an annular spring 23. It generates a sufficiently high radial force with which the sealing edge 17 contacts the ring 7. Since the annular spring 23 is located at the level of the sealing edge 17, the radial force is exerted optimally onto the sealing edge 17. The recess 22 has a satisfactory depth so that there is no risk that the annular spring 23 can slide out of the recess 22.

Upon installation of the injector sleeve 1, the radial sealing ring 10 is already mounted. The sealing ring 4 must therefore pass through the radial sealing ring 10 in order for it to reach its mounted position according to FIG. 1. In doing so, the sealing ring 4 must not be displaced on the injector sleeve 1 and must also not be damaged. In order to achieve this, the sealing ring 4 is designed such that it is seated with such elastic deformation on the injector sleeve 1 that a sufficiently high force fit between the sealing ring 4 and the injector sleeve 1 exists. The force fit is so high that the sealing ring 4 will not be displaced upon insertion of the injector sleeve 1. As a result of the detachable connection, the sealing ring 4, as needed, can be simply pulled off the injector sleeve 1 and replaced with a new sealing ring 4.

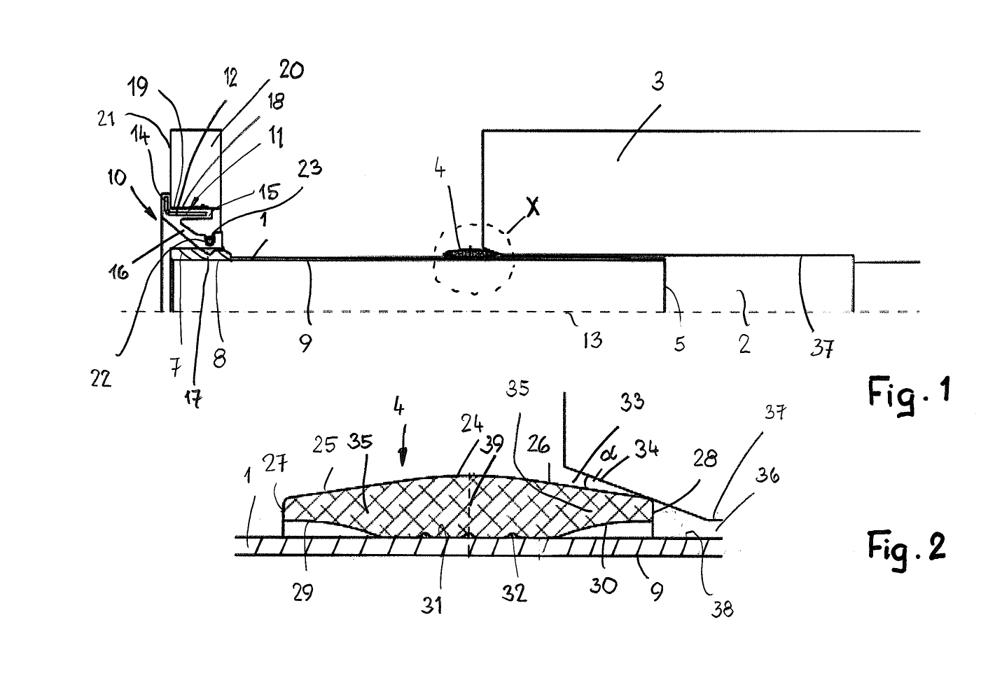

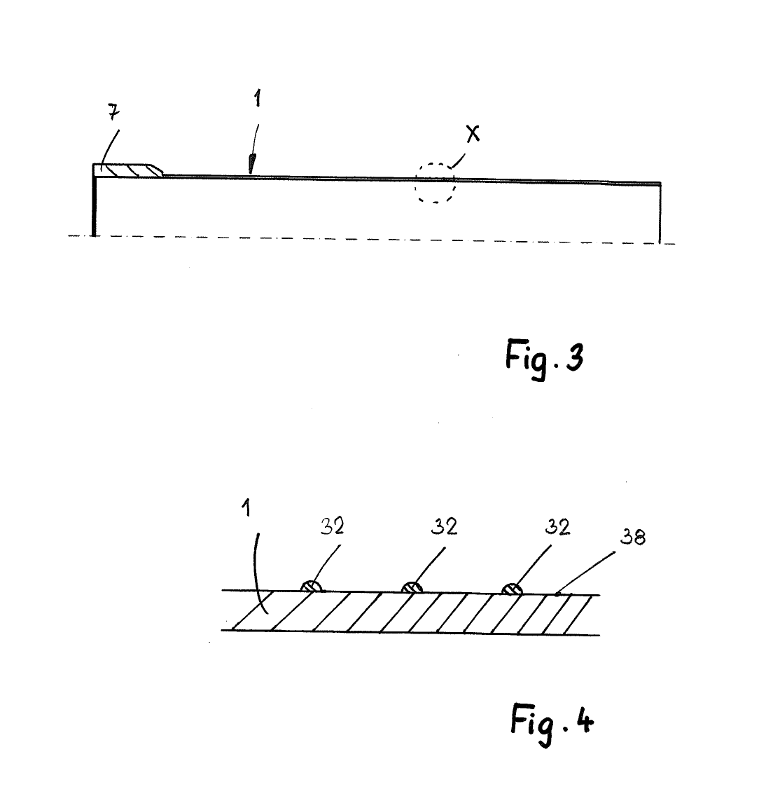

In order for the sealing ring 4 to assume its mounted position without the risk of displacement, the sealing ring 4 has a special constructive configuration which will be explained with the aid of FIG. 2 in more detail. The sealing ring 4 is of a solid configuration and is seal-tightly resting on the injector sleeve 1. Its exterior side is comprised of a central ring part 24 which across its axial width is continuously convexly curved with a large radius of curvature, when viewed in axial section. The central ring part 24 passes into lateral parts 25, 26 which in axial section extend straight and have the same width, respectively. The lateral parts 25, 26 are axially wider than the central ring part 24. The ring part 24 is provided on a center section 39 of the sealing ring 4. The lateral parts 25, 26 are the exterior sides of elastically bendable annular legs 35 which adjoin on both sides the center section 39.

The lateral parts 25, 26 extend up to the annular end face surfaces 27, 28 which are positioned in radial planes and extend parallel to each other. The annular surfaces 27, 28 adjoin concavely curved inner sides 29, 30 which advantageously are of the same length and pass into a cylindrical center part 31. It is axially significantly wider than the annular ring part 24 on the exterior side of the sealing ring 4.

The sealing ring 4 is symmetrically designed so that upon mounting on the injector sleeve 1 no attention must be paid to a correct mounting position of the sealing ring 4.

It is advantageous when, in addition to force fit, the sealing ring 4 also is provided with at least one form fit connection 32 with which an additional securing action relative to displacement on the injector sleeve 1 is ensured, in particular when pushing through the radial sealing ring 10. The form fit connection 32 ensures that the sealing ring 4 reaches its mounted position illustrated in FIG. 1. If the sealing ring 4 were displaced on the injector sleeve 1 when being pushed through the radial sealing ring 10, the sealing ring 4 in the end position of the injector sleeve 1 would not reach its mounted position so that the sealing action of the combustion chamber 2 would no longer be realized.

The form fit connection 32 is formed by at least one welding bead which extends about the circumference of the injector sleeve 1. The welding bead can be positioned in a radial plane. However, it is advantageous when the welding bead 32 extends in a coil shape about at least two turns. In the embodiment, the welding bead 32 is coil-shaped and extends about three turns wherein the individual coil sections have a spacing from each other. The total width of the welding bead 32 is smaller than the axial width of the cylindrical center part 31 of the sealing ring 4. It is formed in the area of this center part 31 with an overlap size so that the sealing ring 4 is elastically widened when it is seated on the injector sleeve 1. The welding bead 32 penetrates into the cylindrical center part 31 which becomes elastically deformed in the area of the welding bead turns. Since the welding bead 32 is a raised portion on the injector sleeve 1, a form fit connection between the injector sleeve 1 and the sealing ring 4 is formed which ensures that the sealing ring 4 upon mounting of the injector sleeve 1 will not be displaced. Since the inner sides 29, 30 of the sealing ring 4 are recessed, the sealing ring 4 can be pulled easily onto the injector sleeve, with only the central part of the sealing ring 4 being elastically widened. The oversize of the sealing ring 4 in the area of the center part 31 is selected such that the sealing ring 4 is seated this satisfactory press fit on the injector sleeve 1.

The straight lateral parts 25, 26 on the exterior side of the sealing ring 4, viewed in axial section according to FIG. 2, are positioned slanted at a flat angle relative to the axis 13 of the injector sleeve 1. The slant angle of these lateral parts 25, 26 can be, for example, in a range between approximately 6° to approximately 10°.

These slanted lateral parts 25, 26 facilitate passage of the sealing ring 4 through the radial sealing ring 10 upon mounting. The sealing edge 17 of the radial sealing ring 10 slides easily across the lateral parts 25, 26 so that there is no risk that the sealing edge 17 becomes damaged. Instead of the coil-shaped welding beads 32, individual welding beads that are positioned at an axial spacing adjacent to each other and can be provided on the injector sleeve 1 in a radial plane, but also extending at a slant relative to the radial plane, can be employed also as a displacement securing action.

Instead of the welding bead, also other raised portions may be provided as a displacement securing action 32 which, for example, may be glued onto the injector sleeve 1.

The form fit connection can also be produced in a different way. For example, the injector sleeve 1 in the area of the sealing ring 4 can be provided with a roughened surface structure or a surface coating as a form fit connection. A further possibility, but also an additional possibility, resides in employing an elastomer for the sealing ring 4 that has such a high coefficient of friction that the sealing ring 4 in combination with force fit will not shift upon mounting of the injector sleeve 1.

The cylinder head 3 has at the inlet 33 (FIG. 2) into the combustion chamber 2 a funnel-shaped widened portion 34 which tapers in the direction toward the combustion chamber 2 and forms an inlet bevel. Upon insertion of the injector sleeve 1, the annular leg 35 with its lateral part 26 contacts the wall of the widened portion 34. As a result of the slanted position of the lateral part 26, the latter when impinging on the wall of the widened portion 34 is positioned relative to this wall at an acute angle α. Upon further insertion of the injector sleeve 1 into the combustion chamber 2, the annular leg 35 as a result of the contact of its lateral part 26 on the wall of the widened portion 34 is first elastically inwardly bent in radial direction. As soon as the annular leg 35 has reached the annular gap 36 between the inner wall 37 of the combustion chamber 2 and the cylindrical exterior side 38 of the injector sleeve 1, the annular leg 35 is elastically compressed. Because its radial cross-sectional width increases from the free end, the annular leg 35 is continuously elastically compressed more strongly as insertion of the injector sleeve 1 progresses until the annular gap 36 is completely sealed off (FIG. 1). Since the annular leg 35 in the direction of the annular end face surface 28 decreases in thickness, tolerances in the width of the annular gap 36 can be compensated without problems by interaction with the insertion slant 34.

The welding bead 32 has only a very minimal height which is, for example, approximately 2/10 mm up to approximately 1 mm. The welding bead 32 forms a roughness of the otherwise very smooth exterior side of the injector sleeve and can be applied in a simple way on the exterior side of the injector sleeve.

In the mounted position, the elastically deformed annular leg 35 of the sealing ring 4 is resting areally on the inner wall 37 of the combustion chamber 2 and the exterior side 38 of the injector sleeve 1. In this way, the combustion chamber 2 is optimally sealed.

Since the sealing ring 4 is only pushed onto the injector sleeve 1 and is axially secured by force fit, preferably reinforced by the afore described form fit connection, it can be exchanged without problem. The injector sleeve 1 can therefore be reused after mounting in a service situation.

The sealing ring 4 is comprised of elastomer material, advantageously rubber. It is a constructively simple component that can be produced inexpensively and mounted easily on the injector sleeve 1 as well as demounted, if needed. Due to the described shaping, the sealing ring 4 can be pushed through the radial sealing ring 10 without difficulty. Since the sealing ring 4 is only pushed onto the injector sleeve 1, a pre-treatment of the injector sleeve as it is needed in case of a sealing ring that is vulcanized on, is not required. The force fit and form fit connection 32 enables a sufficiently high axial force transmission upon mounting and demounting, wherein, as a result of the described cross-sectional shape of the sealing ring, no auxiliaries such as lubricants and the like are required upon installation.

What is claimed is:

1-14. (canceled)

15. A combustion chamber gasket seal for internal combustion engines, the combustion chamber gasket seal comprising:
an injector sleeve projecting into a combustion chamber of a cylinder head and carrying at least one elastomer sealing ring that seals the combustion chamber relative to an exterior,
the at least one elastomer sealing ring arranged detachably on the injector sleeve and seated under elastic deformation at least with force fit on the injector sleeve.

16. The combustion chamber gasket seal according to claim 15, wherein the at least one elastomer sealing ring is secured on the injector sleeve in an axial direction of the injector sleeve by at least one form fit connection.

17. The combustion chamber gasket seal according to claim 16, wherein the at least one form fit connection is formed by at least one raised portion on the injector sleeve.

18. The combustion chamber gasket seal according to claim 17, wherein the at least one raised portion is a welding bead.

19. The combustion chamber gasket seal according to claim 16, wherein the at least one form fit connection extends about a circumference of the injector sleeve.

20. The combustion chamber gasket seal according to claim 16, wherein the at least one form fit connection is positioned in a radial plane of the injector sleeve.

21. The combustion chamber gasket seal according to claim 16, wherein the at least one form fit connection is coil-shaped and extends about at least one turn of a coil.

22. The combustion chamber gasket seal according to claim 16, wherein the at least one elastomer sealing ring comprises a center part and the center part is seated with elastic deformation on the injector sleeve in an area where the at least one form fit connection is located.

23. The combustion chamber gasket seal according to claim 22, wherein the center part comprises a cylindrical inner side.

24. The combustion chamber gasket seal according to claim 22, wherein the at least one elastomer sealing ring comprises at least one rim area adjoining the center part and, in an unmounted position of the at least one elastomer sealing ring, the at least one rim area has a spacing relative to the injector sleeve.

25. The combustion chamber gasket seal according to claim 24, wherein the at least one rim area has a wall thickness decreasing away from the center part.

26. The combustion chamber gasket seal according to claim 24, wherein the at least one rim area comprises an exterior side and an inner side, wherein the exterior side, viewed in an axial section view through the at least one elastomer sealing ring, is positioned slantedly at an acute angle relative to an axis of the at least one elastomer sealing ring.

27. The combustion chamber gasket seal according to claim 26, wherein the at least one rim area of the at least one elastomer sealing ring in a mounted position of the injector sleeve is elastically deformed such that the exterior side of the at least one elastomer sealing ring is resting areally on a wall of the combustion chamber and the inner side of the at least one elastomer sealing ring is resting areally on an exterior side of the injector sleeve.

28. The combustion chamber gasket seal according to claim 24, wherein the at least one elastomer sealing ring has a symmetrical cross-section.

29. The combustion chamber gasket seal according to claim 15, wherein the combustion chamber has an insertion area where the injector sleeve is inserted and wherein the insertion area is embodied to widen in a direction opposite to an insertion direction of the injector sleeve.
